(19) United States
(12) Patent Application Publication
(10) Pub. No.: US 2018/0232121 A1
(43) Pub. Date: Aug. 16, 2018

(54) PERPENDICULAR AUTOPLAY VIDEO FEED RELATED NAVIGATION

(71) Applicant: Google Inc., Mountain View, CA (US)

(72) Inventors: Justin Lewis, Marina del Rey, CA (US); Ruxandra Georgiana Paun, Santa Monica, CA (US)

(21) Appl. No.: 14/450,161

(22) Filed: Aug. 1, 2014

(51) Int. Cl. G06F 3/0485; G06F 3/0481; H04L 29/08

(52) U.S. Cl. CPC G06F 3/0485; H04L 67/10; G06F 3/0481

(57) ABSTRACT

Presenting related content for a shared media item is disclosed. A method includes presenting, by a user device, a user interface (UI) including a first scrollable portion that is scrollable in a first direction, and a second scrollable portion that is scrollable in a second direction and is adjacent to the first scrollable portion. The first scrollable portion includes a first media item. The method further includes presenting a representation of a second media item in the second scrollable portion. The second media item is related to the first media item. The method further includes receiving an indication that the second media item is to be presented in the first scrollable portion. The method further includes in response to the received indication, playing the second media item in the first scrollable portion and presenting a representation of the first media item in the second scrollable portion.

### TECHNICAL FIELD

Implementations of the present disclosure relate to providing content, and more specifically, to providing content related to a shared media item in a user interface.

### BACKGROUND

The Internet allows people to obtain information, connect with others and share information with each other. Common Internet destinations include news websites, content sharing platforms, social networking platforms, and the like. Many websites and platforms include a content sharing aspect that allows users to upload, view, and share media items, such as video content, image content, audio content, and so on. Other users may comment on the shared content, discover new content, locate updates, share additional content, and otherwise interact with the provided content. The shared media items may include content from professional content creators, e.g., creators of movies, music, and articles, as well as media items from amateur content creators, e.g., creators of video and photo blogging, short original videos, and status updates.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an implementation, a method includes presenting, by a user device, a user interface (UI) that includes a first scrollable portion that is scrollable in a first direction, and a second scrollable portion that is scrollable in a second direction and is adjacent to the first scrollable portion. The first scrollable portion includes a first media item. The method further includes presenting a representation of a second media item in the second scrollable portion. The second media item is related to the first media item. The method further includes receiving an indication that the second media item is to be presented in the first scrollable portion. The method further includes in response to the received indication, playing the second media item in the first scrollable portion and presenting a representation of the first media item in the second scrollable portion.

In some implementations, the indication can be input from a user to view the second media item. The indication can be to indicate that the first media item is finished playing back. The first media item and the second media item can be part of a set of episodic media items. The first media item and the second media item can be part of a same channel. The first direction can be perpendicular to the second direction. The method can include receiving an input to move the first scrollable portion in the first direction. The method can further include in response to the input, scrolling the first scrollable portion in the first direction and scrolling the second scrollable portion in the first direction such that the second scrollable portion remains adjacent to the first scrollable portion. The method can include presenting the first media item in the first scrollable portion in response to a request to share the first media item. The UI can include a feed. The first media item can be part of one of a plurality of social shares in the feed.

In additional implementations, computing devices for performing the operations of the above described implementations are also disclosed. Additionally, in implementations of the disclosure, a computer readable storage media stores methods for performing the operations of the above described implementations. Further, in implementations of the disclosure, means for performing the operations of the above described implementations are also disclosed.

### BRIEF DESCRIPTION OF THE DRAWINGS

The present disclosure is illustrated by way of example, and not by way of limitation, in the figures of the accompanying drawings.

FIG. 1 illustrates an example system architecture, in accordance with one implementation of the disclosure.

FIG. 2 is a flow diagram illustrating a method for providing related content for a shared media item on a client device, according to some implementations of the disclosure.

FIGS. 3A-3D are example screenshots illustrating User Interfaces (UIs) for presenting a media item and related content, according to some implementations of the disclosure.

FIG. 4 is a block diagram illustrating an example computer system, according to some implementations.

### DETAILED DESCRIPTION

Described herein is a mechanism for handling presentation of content that is related to a shared media item. Conventionally, a media item platform may present a media item to a viewing user in response to a request from another user to share the media item. Conventional systems, however, typically are not effective at presenting related content to viewers of the shared media item, especially when presenting related content on a mobile device where the available presentation area is limited. While some conventional media platforms may present advertisements to the viewing user, the advertisements are typically related to demographics of the user and not necessarily to the shared media item (e.g., related to the content of the shared media item). Other conventional approaches may automatically play related content after a certain media item (e.g., a video) is done playing. For example, for episodic content, a next episode may be automatically played when the particular video (the earlier episode) is finished playing. For shared media items, however, conventional systems may not provide related content to viewers of the shared media item in a meaningful way. In chat conversations, for example, conventional systems typically do not display related content with a video shared by a user with another user—especially when the other user views the shared video on a mobile device with a relatively small screen area. In another example, when a shared media item is presented as part of a feed item within a feed, conventional systems may display related content as part of a separate feed item. Under conventional approaches, it may not be apparent to a viewer that the additional content is related to the shared media item.

Implementations of the present disclosure address the above and other deficiencies of conventional systems by presenting content that is related to a shared media item in a meaningful way. For clarity in explanation, the present disclosure is described, by way of example, in terms of a user interface (UI) with at least one scrollable portion. In particular, a UI that includes a shared media item may be presented to a user. The UI may also include a scrollable portion that includes content that is related to the media item. The scrollable portion may be presented adjacent to the media item in the UI. For example, the scrollable portion may be presented horizontally with respect to the shared media item. The user may navigate (e.g., scroll) through the scrollable portion to browse the content that is related to the shared media item. In implementations, the related content includes a related media item that may be played back to the user via the UI.

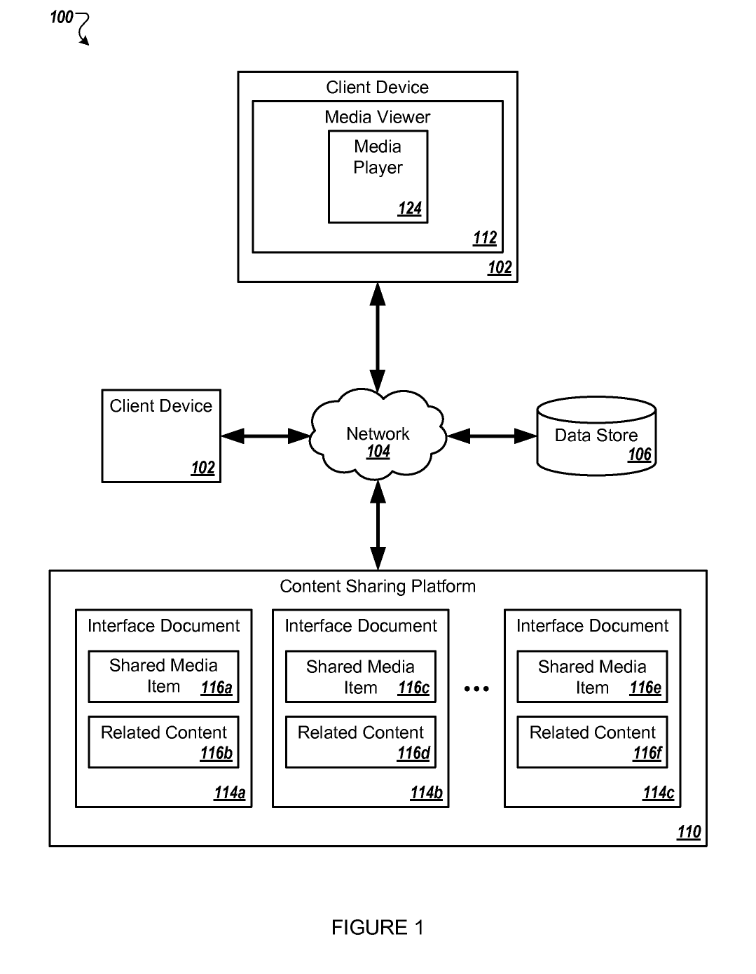

FIG. 1 illustrates an example system architecture 100, in accordance with one implementation of the disclosure, for providing related content for a shared media item. The system architecture 100 includes any number of client devices 102, a network 104, a data store 106, and a content sharing platform 110.

The one or more client devices 102 may each include computing devices such as personal computers (PCs), laptops, mobile phones, smart phones, tablet computers, netbook computers etc. In some implementations, client device 102 may also be referred to as “user devices.”

In one implementation, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In one implementation, the data store 106 may be a memory (e.g., random access memory), a cache, a drive (e.g., a hard drive), a flash drive, a database system, or another type of component or device capable of storing data. The data store 106 may also include multiple storage components (e.g., multiple drives or multiple databases) that may also span multiple computing devices (e.g., multiple server computers).

In one implementation, the content sharing platform 110 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to media items and/or provide the media items to the user. For example, the content sharing platform 110 may allow a user to consume, upload, search for, approve of (“like”), dislike, and/or comment on media items. The content sharing platform 110 may also include a website (e.g., a webpage) that may be used to provide a user with access to the media items. Content sharing platform 110 may include any type of content delivery network providing access to content and/or media items and can include a social network, a news outlet, a media aggregator, a chat service, a messaging platform, and the like. Implementations of the disclosure are not limited to content sharing platforms or to platforms that provide channel subscriptions to users.

Each client device includes a media viewer 112. In one implementation, the media viewer 112 may be an application that allows users to consume content and media items, such as images, videos, web pages, documents, etc. For example, the media viewer 112 may be a web browser that can access, retrieve, present, and/or navigate content (e.g., web pages such as Hyper Text Markup Language (HTML) pages, digital media items, etc.) served by a web server. The media viewer 112 may render, display, and/or present the content (e.g., a web page, a media item presentation component) to a user. In another example, the media viewer 112 may be a standalone application that allows users to view digital media items (e.g., digital videos, digital images, electronic books, etc.). The media viewer 112 may be provided to the client devices 102 by a server (not shown) and/or content sharing platform 110. For example, the media viewer 112 may include one or more embedded media players that are embedded in web pages provided by the content sharing platform 110. In another example, the media viewer 112 may be an application that is downloaded from the server. In a further example, the media viewer 112 may be a messaging application that permits users to exchange messages, share content and otherwise interact with each other.

The content sharing platform 110 may provide one or more user interface documents 114a-c that can be interpreted by the media viewer 112 on client device 102. The interface document can be any type of electronic document. In some implementations, the interface document is a navigable document where some of the document is visible in a user interface while another portion of the electronic document is not currently visible in the user interface but may become visible based on user input. For example, upon a user activation of a scrolling mechanism (e.g., via a scrollbar, a scroll wheel, a touchscreen movement, automatic scrolling, etc.), different portions of the interface document can become visible while other portions can become no longer visible. The interface document can include one or more portions that can be scrollable vertically, horizontally, or a combination thereof. Examples of interface documents include a web page or a mobile app user interface document presenting a stream of content (frequently updated content) such as a news feed, an activity feed, a social feed, a blog, a web page or a user interface document presenting predefined content such as a home page or a news page, multi-user chats, messaging services, etc. A user can navigate (e.g., via a gesture, scroll, click, swipe, etc.) to portions of the interface document that are not currently visible in the user interface.

Each interface document 114 may include one or more shared media items 116. A shared media item may refer to a media item that a user has shared with one or more other users. Examples of a shared media item 116 can include, and are not limited to, digital video, digital movies, digital photos, photo albums, digital music, website content, social media updates, video-on-demand, live-streamed media, electronic books (ebooks), electronic magazines, digital newspapers, digital audio books, electronic journals, web log (blog) entries, electronic articles, real simple syndication (RSS) feeds, electronic comic books, software applications, advertisements, etc. In some implementations, shared media item 116 is also referred to as a content item. For brevity and simplicity, an online video (also hereinafter referred to as a video) is used as an example of a media item 116. As used herein, “media,” media item,” “online media item,” “digital media,” “digital media item,” “content,” and “content item” can include an electronic file that can be accessed or loaded using software, firmware or hardware configured to present the digital media item to an entity.

Each interface document 114 may include content (related content 118) that is related to a shared media item 116. Related content 118 may refer to any type of content or media item that has any relationship to the shared media item 116. Related content 118 may be the same type of content as the media item 116 to which it is related. For example, when a shared media item is a video, the related content may be a different video of the same genre (e.g., a movie that has related content or the same producer, director or actor), a video from the same channel, a video from any channel to which a viewing user is subscribed, etc. In another example, when the shared media item is a news article, related content can include other news articles of the same topic, of a similar topic or from a same news outlet. In a further example, when the shared media item is a song, related content can include other songs from the same artists, on the same album, in the same genre, etc. Alternatively, some or all of the related content 118 may be a different type of media item as the shared media item 116. For example, when the shared media item is a music video, the related content can be a webpage for the band that plays the song in the music video, a news article about the band, a calendar of upcoming concerts for the band, etc. Example types of related content 118 can include, and are not limited to, digital video, digital movies, digital photos, photo albums, digital music, website content, social media updates, video-on-demand, live-streamed media, electronic books (ebooks), electronic magazines, digital newspapers, digital audio books, electronic journals, web log (blog) entries, electronic articles, real simple syndication (RSS) feeds, electronic comic books, software applications, advertisements, etc. The shared media item 116 and the related content may be presented to a user via the media viewer 112 (e.g., web browser, mobile device application).

In implementations, the interface document 114 can include metadata associated with each shared media item 116. For example, the metadata can include various information about the shared media item 116 and/or related content 118, such as a title, description, keywords, content type, width, height, a graphical representation associated with the media item (e.g., a thumbnail), an address, a username of an owner of the media item, a hashtag associated with the media item, an application name, one or more media item identifiers, whether the media item is to autoplay, whether the media item is to be played back without user input when it is presented in a UI, among others. The metadata may also include information associated with the presentation of the related content 118. The media viewer 112 may use the metadata when presenting content that is related to a media item 116. For example, the metadata may indicate where in a user interface to present the related content 118, when to present the related content 118, a presentation order when the related content 118 includes multiple related media items, etc. In one implementation, the content sharing platform 110 may store the media item 116, the related content 118 and any related metadata in the data store 106.

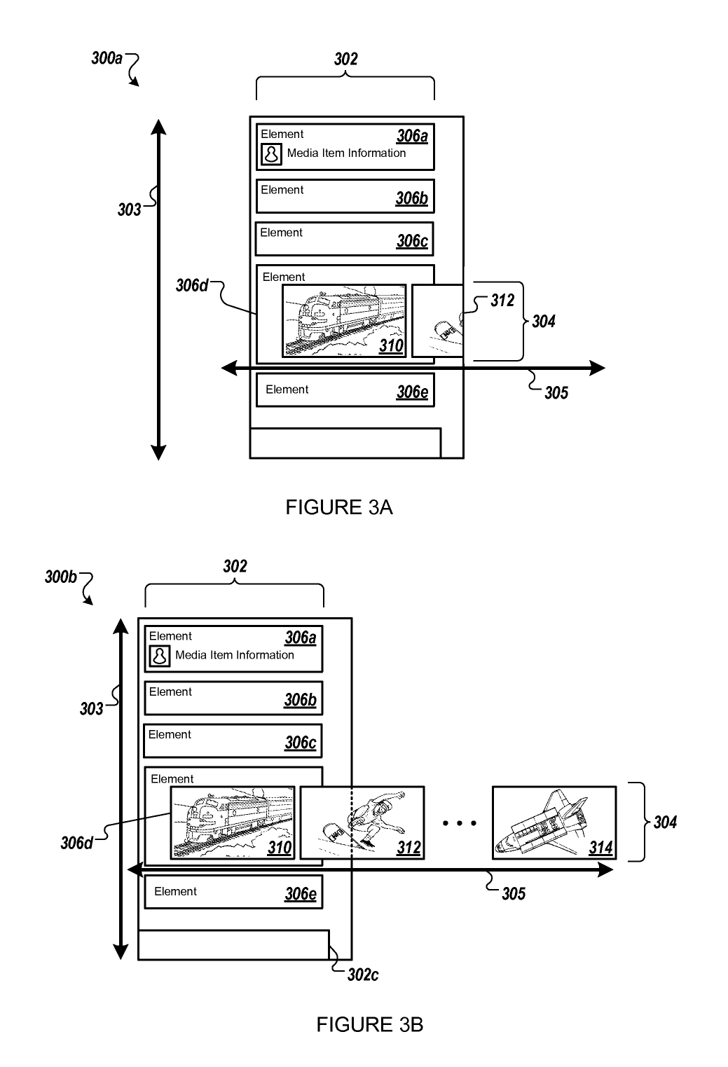

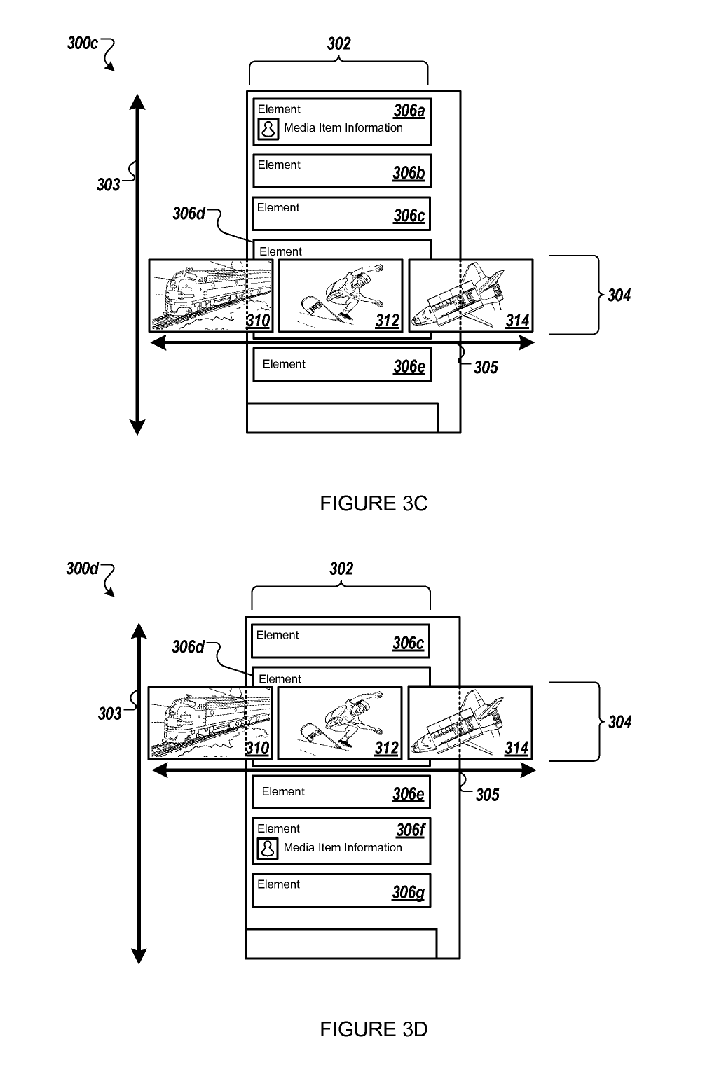

In operation, the media viewer 112 at the client device 102 presents a UI that can include at least one scrollable portion with related content 118. In some implementations, the UI includes a first scrollable portion that is scrollable in a first direction, and a second scrollable portion that is scrollable in a second direction. The second scrollable portion can be adjacent to the first scrollable portion, an example of which is described in conjunction with FIGS. 3A-D. The first scrollable portion can include a first media item (e.g., shared media item 116). The second scrollable portion can include related content 118. In some implementations, the related content can be a representation of a second media item (e.g., a thumbnail of a media item). For example, when the shared media item 116 is a video, the related content can be any number of related videos. The second scrollable portion can include thumbnails of the related videos.

In some implementations, the content sharing platform 120 determines the related content 118 for the shared media item 116. The content sharing platform 120 can use metadata and/or other characteristics of the shared media item 116 to determine the related content 118. For example, when a first user shares a video 116 of a prominent rock band, the content sharing platform 120 can determine related content 118 based on metadata associated with the rock band video (e.g., band name, band members, genre, the years that the rock band is/was active). The content sharing platform 120 can identify any type or number of related media items based on the metadata of the rock band video. For example, the content sharing platform 120 can query a database (e.g., a relational database) to identify related content, which can include other songs by the rock band, other songs by similar rock bands, music videos of the rock band, backstage videos of the rock band, news articles that feature the rock band, upcoming concert information for the rock band, etc.

Once the content sharing platform 120 determines the related content 118 for the shared media item 116, the content sharing platform 120 can create instructions for how the media viewer 112 is to present the related content 118. For example, the instructions can indicate that the related content 118 is to be presented in a scrollable portion of an interface that is adjacent to the shared media item 116. The instructions can also indicate whether the media viewer 112 is to use the related content 118, or to use a representation of the related content 118 (e.g., thumbnail) and later, in response to an indication to present the related content 118, obtain the actual related content 118. The instructions can also indicate where to request the related content 118 from (e.g., an address of a server). In an example, the instructions can indicate that the media viewer is to obtain thumbnails of the first ten related content items 118. When the user scrolls toward the end of the first ten related content items 118, the media viewer 112 is to obtain thumbnails for the next ten relate content items 118. In another example, the instructions can indicate that the media viewer 112 is to obtain all or part of a first set (e.g., first ten) of videos 118. When the user scrolls toward the end of the first ten related content items 118, the media viewer 112 is to obtain thumbnails for a second set (e.g., second ten) of videos 118. When the media viewer 112 obtains part of a video, the media viewer 112 can request more parts of the video.

The media viewer can receive the instructions on how to render the related content 118 in the UI. In some implementations, the media viewer 112 receives the instructions from the source of the shared media item (e.g., the content sharing platform 110). In other implementations, the media viewer 112 receives the instructions from a related content service (e.g., an advertisement service). The instructions can include information on the placement of the related content. For example, the instructions can indicate that the related content 118 is to be presented adjacent to the shared media item 116. In yet a further example, the instructions can indicate that the related content 118 is to be presented in a scrollable portion of a UI and adjacent to the shared media item 116, as further described in conjunction with FIGS. 3A-D.

In some implementations, the UI provides constantly updated content in the form of a feed interface document 114 (feed). Various activities can be collected and presented to a user via the feed 114. For example, the feed 114 can include any number of shared media items 116 from media item sources to which the user is associated. Once a user subscribes to or follows a media item source (e.g., a channel, an entity, an individual), the user can be presented with information from the media item source on the feed 114. If a user subscribes to multiple media item sources, media items from each media item source to which the user is subscribed can be combined into a syndicated feed 114.

In situations in which the systems discussed here collect personal information about users, or may make use of personal information, the users may be provided with an opportunity to control whether the content sharing platform 110 collects user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the content sharing platform 110.

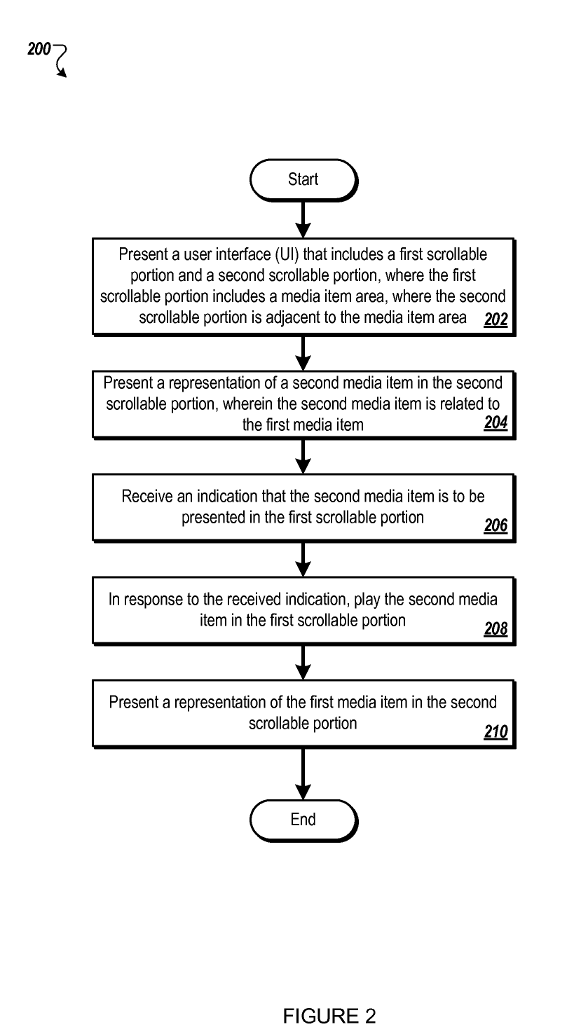

FIG. 2 is a flow diagram illustrating a method 200 for providing related content for a shared media item on a client device, according to some implementations of the disclosure. The method 200 may be performed by processing logic that comprises hardware (e.g., circuitry, dedicated logic, programmable logic, microcode, etc.), software (e.g., instructions run on a processing device to perform hardware simulation), or a combination thereof.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 200 may be performed by the client device 102 of FIG. 1.

Referring to FIG. 2, method 200 begins at block 202 when processing logic presents a user interface (UI) that includes a first scrollable portion that is scrollable in a first direction. The first scrollable portion includes a first media item. The UI can also include a second scrollable portion that is scrollable in a second direction and is adjacent to the first scrollable portion, an example of which is described in further detail in conjunction with FIGS. 3A-D.

At block 204, the processing logic presents a representation of a second media item in the second scrollable portion. The representation can be the actual second media item or can be a thumbnail, a title, an image, etc. that represents the second media item. For example, the representation can be a thumbnail of a video that includes an overlayed play symbol to indicate to a user that the second media item is playable. The second media item is related to the first media item, as described herein.

At block 206, the processing logic receives an indication that the second media item is to be presented in the first scrollable portion. In some implementations, the indication is an explicit request from a user to view the second media item. In other implementations, the indication informs the processing logic that an event has occurred. The indication of the occurrence of the event may then trigger the processing logic to present the second media in the first scrollable portion. For example, the event can be the completion of playback of a first media item. When the first media item is done playing, the indication can indicate to the processing logic that the second media item is to be presented in the first scrollable portion. At block 208, the processing logic presents the second media item in the first scrollable portion in response to the received indication. When presenting the second media item in the first scrollable portion, the processing logic may provide playback of the second media item. For example, when the second media item is a video, the processing video can cause the video to be played back via a user interface.

At block 210, the processing logic can present a representation of the first media item in the second scrollable portion in response to the received indication. When presenting the representation of the first media item in the second scrollable portion, the processing logic may depict movement of the first media item to the second scrollable portion as an animation. Similarly, the processing logic may depict movement of the second media to the first scrollable portion as an animation. For example, the processing logic may present the first scrollable portion as a columnar element and the second scrollable portion as a horizontal row of media items. The first scrollable portion and the second scrollable portion may intersect. The processing logic may provide playback of media items at this intersection of the first scrollable portion and the second scrollable portion. As an example animation, the processing logic may present the first media item at the intersection and the second media item in the second scrollable portion. Upon receiving the indication, the processing logic may animate movement of the first media item from the intersection to the second scrollable portion. At the same time and as part of the same animation, the processing logic may present an animation of the second media item moving from the second scrollable portion to the intersection. In some implementations, the first scrollable portion and the second scrollable portion are perpendicular with respect to each other.

In some implementations, the processing logic presents the first media item in the first scrollable portion in response to a request to share the first media item. For example, a user of a social network may provide a request to share a media item within the social network. In response to the request, the processing logic may present the first media item in the first scrollable portion, such as in a social share. A social share refers to content (e.g., post, feed item) resulting from a user sharing a media item (e.g., via a share request) via a social network or a content sharing service. The content sharing service can present social shares to users in one or more feeds (e.g., social feeds, news feeds). The social shares can include references to media items (e.g., a URL that directs a viewing user to a hosted video).

In some implementations, the processing logic may receive an input to move the first scrollable portion in the first direction. In response to the input, the processing logic may scroll the first scrollable portion in the first direction and scroll the second scrollable portion in the first direction such that the second scrollable portion remains adjacent to the first scrollable portion, as further described in conjunction with FIGS. 3C-D.

FIGS. 3A-D illustrate four example states 300a-d of a UI 300 that can include a shared media item 310 and content (e.g., media items 312 and 314, or representations thereof) that is related to the shared media item 310 in a scrollable portion, in accordance with some implementations. In some implementations, the UI 300 includes a first scrollable portion 302 that includes any number of elements 306a-e. The elements 306a-e can be any type or kind of document element, such as a post, feed item, blurb, social message, blog entry, news item, media item, aggregation item, chat message, or the like. For example, the elements 306a-e can include status updates shared by a user's social contacts within a social network. In some implementations, each element 306 is a chat message and can be from any user who is part of the chat. When the user navigates to other portions of the UI (such as by scrolling the UI in the first direction 303), some of the elements 306a-e may disappear from view while other elements appear in the UI. The UI can include elements 306a-e and upon user input to navigate to another portion of the UI, any or all of elements 306a-e can disappear from view, as illustrated in FIG. 3D. In implementations, an element 306 can include one or more shared media items (e.g., shared media item 310). The UI 300 can also include a second scrollable portion 304 that includes at least one related media item 312.

FIG. 3A illustrates an example state 300a of UI 300. When in state 300a, the UI can present a first media item 310 in a first scrollable portion 302 that is scrollable in a first direction 303. In some implementations, such as when the first media item 310 is a video, the first media item 310 can be played in the UI. The UI can also present a related media item 312 in a second scrollable portion 304 that is scrollable in a second direction 305.

As illustrated in example state 300b of the UI in FIG. 3B, the second scrollable portion 304 includes related media items 312 and 314. Any number of media items may be included in the second scrollable portion 304. The at least one related media item can be presented in the UI 300 in such a way as to instruct a user that the at least one related media item is accessible via the scrollable portion. For example, the UI can present part of a related media item (e.g., media item 312) within the UI while part of the related media item is not presented in the UI. This may impress upon a user that the related media item is watchable once it appears within the UI and would thus encourage the user to touch the related media item in the UI and slide the related media item such that it appears within the UI, as illustrated in FIG. 3C.

Example UI state 300c in FIG. 3C also illustrates a portion of the shared media item 310 in the UI 300c while a portion of the shared media item 310 is not visible in the UI state 300c. Similarly, a portion of another related media item 314 appears in the UI state 300c while a portion of the other related media item 314 does not appear in the UI state 300c.

FIG. 3D illustrates an example state 300d of the UI 300 after the UI has received input to scroll the first scrollable portion 302 in the first direction 303. As illustrated, elements 306a and 306b, which were illustrated in UI state 300a, are no longer presented in the UI. Elements 306f and 306g are now presented in the UI state 300d. Also illustrated, the entire second scrollable portion 304 is moved in the first direction the same distance as the first scrollable portion 302. In the manner, the second scrollable portion 304 is moved relative to the shared media item 310.

Information corresponding to the media item currently playing in the media player portion, such as metadata, may be shown in a media item information portion (not shown) of the UI 300. For example, information about a video, such as its title, view count, likes, etc. can be presented via the UI 300. Additional menu options (not shown) related to the media item currently playing in the media player portion may also be shown in UI 300, such as play, pause, stop, fast forward, rewind, social post, add comment, etc. In some implementations when a user is viewing the UI 300 on a large screen, all or part of metadata can remain visible with the media player portion. In implementations, the media player portion can include an icon or a “tag” that a user can activate to bring the corresponding post back on screen.

In implementations, the metadata can appear within the UI 300, but when a user scrolls to another portion of the scrollable portion and the media player portion appears, the metadata can collapse to a minimized form. In some instances, when a user activates a media item, the metadata can expand. The metadata can expand over other elements of the scrollable portion. Alternatively, the other elements of the scrollable portion can be moved to make room for presentation of the metadata. Metadata can disappear, or be presented inside the media player portion and can cover part of a playing media item. The media player portion may include a minimization indicator (not shown). The user may minimize the media player portion within the UI 300 by selecting the minimization indicator.

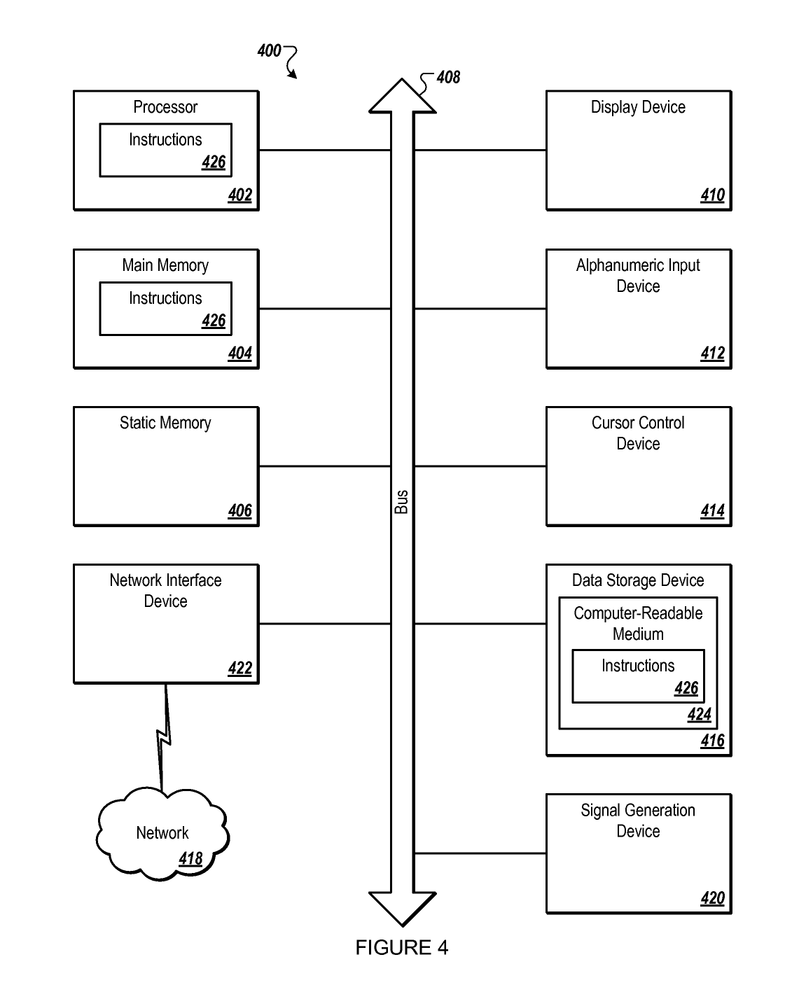

FIG. 4 illustrates a diagrammatic representation of a machine in the example form of a computer system 400 within which a set of instructions, for causing the machine to perform any one or more of the operations or methodologies discussed herein, may be executed. In alternative implementations, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the operations or methodologies discussed herein.

The example computer system 400 includes a processing device (processor) 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage device 416, which communicate with each other via a bus 408.

Processor 402 represents one or more general-purpose processing devices such as a microprocessor, central processing unit, or the like. More particularly, the processor 402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 may also be one or more special-purpose processing devices such as an application specific integrated circuit (ASIC), a field programmable gate array (FPGA), a digital signal processor (DSP), network processor, or the like. The processor 402 is configured to execute instructions 426 for performing the operations and methodologies discussed herein.

The computer system 400 may further include a network interface device 422. The computer system 400 also may include a video display unit 410 (e.g., a liquid crystal display (LCD), a cathode ray tube (CRT), or a touch screen), an alphanumeric input device 412 (e.g., a keyboard), a cursor control device 414 (e.g., a mouse), and a signal generation device 420 (e.g., a speaker).

The data storage device 416 may include a computer-readable storage medium 424 on which is stored one or more sets of instructions 426 (e.g., software) embodying any one or more of the methodologies or functions described herein. The instructions 426 may also reside, completely or at least partially, within the main memory 404 and/or within the processor 402 during execution thereof by the computer system 400, the main memory 404 and the processor 402 also constituting computer-readable storage media. The instructions 426 may further be transmitted or received over a network 418 via the network interface device 422.

In one implementation, the instructions 426 include instructions for a providing one or more dynamic media players, which may correspond, respectively, to the media viewer 112 with respect to FIG. 1, and/or a software library containing methods that provide one or more dynamic media players player for a content sharing platform. While the computer-readable storage medium 424 is shown in an example implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “presenting”, “scrolling”, “determining”, “enabling”, “preventing,” “modifying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same implementation unless described as such.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.”

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

1. A method comprising:
presenting, by a processing device, a user interface (UI) comprising a first scrollable portion that is scrollable in a first direction, and a second scrollable portion that is scrollable in a second direction and is adjacent to the first scrollable portion, wherein the first scrollable portion includes a first media item that is playing in an intersection of the first scrollable portion and the second scrollable portion;
presenting a representation of a second media item in the second scrollable portion, wherein the second media item is related to the first media item;
receiving an indication that the second media item is to be presented in the intersection in response to a completion of the playing of the first media item in the intersection of the first scrollable portion and the second scrollable portion;
in response to the received indication, playing the second media item in the intersection of the first scrollable portion and the second scrollable portion and presenting a representation of the first media item in the second scrollable portion; and
providing information of the second media item that is being played in the intersection with playback options for a media player that is playing the second media item, the information and the playback options being provided at an element of the first scrollable portion that is changed in response to the second media item being played, wherein the changing of the element of the first scrollable portion causes a moving of another element of the first scrollable portion in the first direction.

2. The method of claim 1, further comprising:
in response to a subsequent indication from a user to view a subsequent media item that is included in the second scrollable portion, presenting the subsequent media item in the intersection.

3. (canceled)

4. The method of claim 1, wherein the first media item and the second media item are part of a set of episodic media items.

5. The method of claim 1, wherein the first media item and the second media item are part of a same channel.

6. The method of claim 1, wherein the first direction is perpendicular to the second direction.

7. The method of claim 1 further comprising:
receiving an input to move the first scrollable portion in the first direction; and
in response to the input, scrolling the first scrollable portion in the first direction and scrolling the second scrollable portion in the first direction such that the second scrollable portion remains adjacent to the first scrollable portion.

8. The method of claim 1 further comprising presenting the first media item in the intersection in response to a request to share the first media item.

9. The method of claim 1, wherein the UI comprises a feed, and wherein the first media item is part of one of a plurality of social shares in the feed.

10. An apparatus comprising:
a memory; and
a processing device communicably coupled with the memory, the processing device to:
present a user interface (UI) comprising a first scrollable portion that is scrollable in a first direction, and a second scrollable portion that is scrollable in a second direction and is adjacent to the first scrollable portion, wherein the first scrollable portion includes a first media item that is playing in an intersection of the first scrollable portion and the second scrollable portion;
present a representation of a second media item in the second scrollable portion, wherein the second media item is related to the first media item;
receive an indication that the second media item is to be presented in the intersection in response to a completion of the playing of the first media item in the intersection of the first scrollable portion and the second scrollable portion;
in response to the received indication, play the second media item in the intersection of the first scrollable portion and the second scrollable portion and present a representation of the first media item in the second scrollable portion; and
provide information of the second media item that is being played in the intersection with playback options for a media player that is playing the second media item, the information and the playback options being provided at an element of the first scrollable portion that is changed in response to the second media item being played, wherein the changing of the element of the first scrollable portion causes a moving of another element of the first scrollable portion in the first direction.

11. The apparatus of claim 10, wherein the processing device is further to:
in response to a subsequent indication from a user to view a subsequent media item that is included in the second scrollable portion, presenting the subsequent media item in the intersection.

12. The apparatus of claim 10, wherein the first direction is perpendicular to the second direction.

13. The apparatus of claim 10, wherein the processing device is further to:
receive an input to move the first scrollable portion in the first direction; and
in response to the input, scroll the first scrollable portion in the first direction and scrolling the second scrollable portion in the first direction such that the second scrollable portion remains adjacent to the first scrollable portion.

14. A non-transitory machine-readable storage medium storing instructions which, when executed, cause a processing device to perform operations comprising:
presenting a user interface (UI) comprising a first scrollable portion that is scrollable in a first direction, and a second scrollable portion that is scrollable in a second direction and is adjacent to the first scrollable portion, wherein the first scrollable portion includes a first media item that is playing in an intersection of the first scrollable portion and the second scrollable portion;
presenting a representation of a second media item in the second scrollable portion, wherein the second media item is related to the first media item;
receiving an indication that the second media item is to be presented in the intersection in response to a completion of the playing of the first media item in the intersection of the first scrollable portion and the second scrollable portion;
in response to the received indication, playing the second media item in the intersection of the first scrollable portion and the second scrollable portion and presenting a representation of the first media item in the second scrollable portion; and
providing information of the second media item that is being played in the intersection with playback options for a media player that is playing the second media item, the information and the playback options being provided at an element of the first scrollable portion that is changed in response to the second media item being played, wherein the changing of the element of the first scrollable portion causes a moving of another element of the first scrollable portion in the first direction.

15. The non-transitory machine-readable storage medium of claim 14, wherein the operations further comprising:
in response to a subsequent indication from a user to view a subsequent media item that is included in the second scrollable portion, presenting the subsequent media item in the intersection.

16. (canceled)

17. The non-transitory machine-readable storage medium of claim 14, the operations further comprising presenting the first media item in the first scrollable portion in response to a request to share the first media item.

18. The non-transitory machine-readable storage medium of claim 14, wherein the UI comprises a feed, and wherein the first media item is part of one of a plurality of social shares in the feed.

19. The non-transitory machine-readable storage medium of claim 14, the operations further comprising:
receiving an input to move the first scrollable portion in the first direction; and
in response to the input, scrolling the first scrollable portion in the first direction and scrolling the second scrollable portion in the first direction such that the second scrollable portion remains adjacent to the first scrollable portion.

20. The non-transitory machine-readable storage medium of claim 14, wherein the first direction is perpendicular to the second direction.

21. (canceled)
